(19) United States
(12) Patent Application Publication
(10) Pub. No.: US 2024/0372117 A1
(43) Pub. Date: Nov. 7, 2024

(54) METHOD OF PRODUCING MEMBRANE ELECTRODE ASSEMBLIES IN THE FORM OF A CONTINUOUS WEB

(71) Applicant: Greenerity GmbH, Alzenau (DE)

(72) Inventors: Sarayut Leeratanaphanit, Offenbach am Main (DE); Dieter Bangel, Hüttenberg (DE); Jens-Peter Suchsland, Alzenau (DE)

(73) Assignee: Greenerity GmbH, Alzenau (DE)

(21) Appl. No.: 18/690,009

(22) PCT Filed: Sep. 1, 2022
(86) PCT No.: PCT/EP2022/074361

§ 371 Date: Mar. 7, 2024

(30) Foreign Application Priority Data
Sep. 10, 2021 (DE) 10 2021 123 475.1

(51) Int. Cl. H01M 8/0286; H01M 8/0276; H01M 8/1004

(52) U.S. Cl. CPC H01M 8/0286; H01M 8/0276; H01M 8/1004

(57) ABSTRACT

The invention relates to a first and a second method for the efficient, automated, exact and cost-efficient production of multi-layer continuous webs of membrane electrode assemblies which are suitable for the use in fuel cells, water electrolysis cells, electrochemical compressors and electrochemical sensors.

### TECHNICAL FIELD

This disclosure relates to a first and a second method for the efficient, automated, exact and cost-efficient production of a multi-layer continuous web of membrane electrode assemblies which are suitable for the use in fuel cells, water electrolysis cells, electrochemical compressors and electrochemical sensors.

### BACKGROUND

Methods of producing membrane electrode assemblies are well-known. For example, EP 1 629 559 B1 describes a method of producing a membrane coated with a catalyst, a so-called CCM (catalyst coated membrane). The CCM comprises a circumferential rim made of rim material which serves as a seal so that during the use of the CCM reaction gases cannot escape from the reaction region into the environment. A disadvantage of the described method is that the catalyst coated membrane is used as a continuous web, wherein a large part of the membrane area is covered by the rim material. In other words, an overlapping region between membrane and rim material is very large so that a large part of the active region of the membrane cannot be used and thus, the membrane utilization is very low which is connected with high costs.

### SUMMARY

Provided herein is a method of the production of membrane electrode assemblies in the form of a continuous web, wherein the membrane electrode assemblies each include a layer assembly with a membrane which is arranged between an anode and a cathode as well as a frame-shaped seal which at least surrounds the outer rims of the layer assembly so that an inner region of the layer assembly being surrounded by the frame-shaped seal is exposed, including providing of a first seal material as roll goods, wherein the first seal material is arranged on a first protective foil, providing of a second seal material as roll goods, wherein the second seal material is arranged on a second protective foil, generating of first frame-shaped partial seals from the first seal material so that the first protective foil is not damaged, arranging of a first carrier foil on the first partial seals, generating of second frame-shaped partial seals from the second seal material so that the second protective foil is not damaged, feeding and depositing of the first frame-shaped partial seals on a web-shaped transport material being arranged on a first transport medium under removing the first protective foil, providing of layer assembly material consisting of anode, cathode and membrane lying in between as roll goods, cutting into size of layer assemblies from the layer assembly material, depositing of the layer assemblies on the first frame-shaped partial seals being present on the transport material, feeding and depositing of the second frame-shaped partial seals on the layer assemblies being arranged on the first frame-shaped partial seals under removing the second carrier foil so that window-like sections of the first frame-shaped partial seals and window-like sections of the second frame-shaped partial seals are congruently arranged and assemblies are obtained, wherein on the first seal material and/or on the second seal material an adhesive material is arranged such or a radiation-curable material is arranged such that after arranging the first partial seals, the layer assemblies and the second partial seals one upon the other the adhesive material or the radiation-curable material is arranged between the first and second partial seals being arranged one upon the other, thermally activating of the adhesive material or radiation-curing of the radiation-curable material and compressing of the assemblies under obtaining membrane electrode assemblies with frame-shaped seals as continuous roll goods, arranged on the web-shaped transport material.

Also provided herein is a method of the production of membrane electrode assemblies in the form of a continuous web, wherein the membrane electrode assemblies each include a layer assembly with a membrane which is arranged between an anode and a cathode, a frame-shaped seal as well as gas diffusion plies, wherein the frame-shaped seal at least surrounds the outer rims of the layer assembly so that an inner region of the layer assembly being surrounded by the frame-shaped seal is exposed, including providing of membrane electrode assemblies in the form of roll goods with a cathode, an anode and a membrane lying in between as well as a seal frame surrounding at least the outer rims of the membrane electrode assemblies and arranging of first gas diffusion plies on first sides of the membrane electrode assemblies and/or of second gas diffusion plies on second sides of the membrane electrode assemblies.

### DESCRIPTION OF THE DRAWINGS

FIG. 1 shows a schematic presentation for illustrating method steps of a method of producing three-ply membrane electrode assemblies according to a first example.

FIG. 2 shows a schematic presentation for illustrating method steps of a method of producing five-ply membrane electrode assemblies according to a second example.

### LIST OF REFERENCE SIGNS

1 first seal material
2 first carrier foil
2a cover foil
3 first protective foil
4 layer assembly material
5 layer assembly carrier foil
6 first partial seals
7 layer assemblies
8 second seal material
8a second partial seals
9 second protective foil
10 assemblies
11 membrane electrode assemblies
12 gas diffusion plies
20 first roll
21 second roll
21a further roll
22 guiding rolls
23 cutting device
23a third roll
23b rotating blade
23c delamination roll
24 fourth roll
25 marking device
26 fifth roll
27 cutting device
27a sixth roll
27b rotating blade
28 seventh roll
28a eighth roll
29 cutting device
29a ninth roll
29b rotating blade
29c tenth roll
29d eleventh roll
29e twelfth roll
30 fixing device
31 first adhesive application device
32 curing device
32a protection device
33 magazine
34 gas diffusion ply application device
35 second adhesive application device
36 magazine
37 vacuum transport belt
38 15th roll
39 cutting device
40 camera system
41 transport medium
42 16th roll
43 camera system
44 storage container
45 membrane electrode assemblies with gas diffusion plies
46 13th roll
47 14th roll
48 second carrier foil
49 cover foil
A device for applying a DataMatrix code
B device for checking the DataMatrix code
C device for the quality control of the membrane electrode assemblies
D sensor
E device for the quality control of the three-ply membrane electrode assemblies
F device for defect marking
G device for defect marking verification
H sensor

### DETAILED DESCRIPTION

It could therefore be helpful to provide efficient, automated, exact and at the same time cost-efficient methods of producing multi-layer membrane electrode assemblies in the form of a continuous web which, in addition, can be realized in a simple manner without high technical effort.

Provided herein is a method in which membrane electrode assemblies in the form of a continuous web are generated. The membrane electrode assemblies each comprise a layer assembly with a membrane which is arranged between an anode and a cathode. In addition, a seal having the shape of a frame is present which at least surrounds the outer rims of the layer assembly so that an inner region of the layer assembly being surrounded by the frame-shaped seal is exposed. In other words, membrane electrode assemblies are described in which our membrane being introduced between an anode and a cathode forms a layer assembly surrounded by a seal in the form of a window frame such that an exposed window-like section of the layer assembly is surrounded by the frame-like seal.

At first, our method comprises a step of providing a first seal material that generates the frame-shaped or frame-like seals as roll goods. Thus, the seal material is not present as seal segments, but as a continuous material rolled up. The first seal material is arranged on a first protective foil also present in the roll goods.

Similarly, a second seal material is also provided as roll goods. Like the first seal material, the second seal material is also arranged on a protective foil, namely on a second protective foil. In this example, the first seal material and the second seal material may be the same or they may be different from each other, wherein the sameness and the difference may relate to the chemical composition and/or to geometric factors. The seal frame generated by the first and second seal materials prevents an undesired escape of reaction gases or reaction liquids or of gases or liquids produced during the reaction using the membrane electrode assemblies.

Then, a step of generating first frame-shaped partial seals from the first seal material is conducted, namely in such a manner that the first protective foil will not be damaged and, therefore, the generated first frame-shaped partial seals are still arranged on the first protective foil.

In the same manner, a step of generating second frame-shaped partial seals from the second seal material is conducted. The generating of the second frame-shaped partial seals is conducted such that the second protective foil will not be damaged and therefore the second partial seals remain on the second protective foil.

The generating of partial seals without cutting the respective protective foil in two is advantageous because the partial seals can continuously be further processed, and it is not necessary to separately temporarily store, stock or transport them.

Then, a first carrier foil is arranged on the first partial seals. Advantageously, the carrier foil may be provided with a cover foil which is removed before the first carrier foil is arranged on the first partial seals.

Then, the generated first frame-shaped partial seals are fed to a first transport medium and they are deposited on it, namely under removing the first protective foil. The first transport medium in detail is not limited, but preferably it may be in the form of a vacuum transport belt with which the first partial seals can be transported in an effective, simple, fast and reliable manner and getting out of place can be avoided. Accordingly, the transport medium can be provided when a transport of components has to be conducted.

In a further method step, layer assembly material consisting of anode, cathode and membrane lying in between is provided as roll goods. This means that the anode, the cathode and the membrane are still not cut to size with respect to their geometric dimensions intended for their use, but that roll goods are used in the form of a layer assembly. Continuous plies of anode, cathode and membrane lying in between are present. This promotes the continuous generation of membrane electrode assemblies (MEA). The layer assembly material may, in particular, be arranged on a transport medium such as, for example, a further carrier foil with which damages can effectively be prevented. For a better transport of the layer assembly material, the carrier foil may be provided with an adherent layer.

Then, from the layer assembly material, layer assemblies are cut into size and they are deposited on the first frame-shaped partial seals being present on the transport material. The cutting into size may be realized by common devices such as a cutting tool, a die cutter or the like. After the depositing of the cut layer assemblies on the first frame-shaped partial seals, the second frame-shaped partial seals are fed to the layer assemblies arranged on the first frame-shaped partial seals, and they are deposited on them, thus on an exposed upper side of the layer assemblies, wherein the second protective foil is removed.

Thus, the first frame-shaped partial seals and the second frame-shaped partial seals circumferentially surround the layer assemblies in the form of seal frames, wherein the layer assemblies are exposed inside. In other words, window-like sections of the first frame-shaped partial seals and window-like sections of the second frame-shaped partial seals are congruently arranged, wherein layer assemblies lying in between each are present. So-called assemblies are generated, wherein an assembly in the following order comprises a first partial seal, a layer assembly and a second partial seal. The orientation of the anode and/or the cathode with respect to the first and/or second partial seal can vary, depending on how the layer assembly consisting of anode, cathode and membrane lying in between is arranged on the first partial seal.

To achieve a good sealing effect, on the first seal material and/or on the second seal material an adhesive material is arranged such or on the first seal material and/or on the second seal material a radiation-curable material is arranged such that, after the arrangement of the first partial seals, the layer assemblies and the second partial seals one upon the other, the adhesive material or the radiation-curable material is arranged between the first and second partial seals being arranged one upon the other.

Then, the sealing effect of the frame-shaped seal being produced from the first and the second partial seals is implemented by thermally activating the adhesive material or by radiation-curing the radiation-curable material, wherein during this step, in addition, the assemblies are compressed to realize a connection of the first and second partial seals with the layer assemblies. Membrane electrode assemblies with frame-shaped seals as continuous roll goods on the first carrier material are obtained which can be arranged on the web-shaped transport material and can be further processed in a continuous process or can be transported for stocking.

A method of producing a continuous web of membrane electrode assemblies is provided which in comparison to prior art is characterized by advantages with respect to an effective, automated generation of membrane electrode assemblies which can be handled in a technically and logistically simple manner, wherein at each time point a continuous and thus time-efficient component guidance and processing is guaranteed.

Membrane electrode assemblies are generated in which catalyst coated membranes are present which can be understood as a composite consisting of an anode, a cathode, as well as a membrane being present between anode and cathode, and, in particular, being able to conduct protons. The catalyst coated membranes are present in the form of a continuous web, in other words, as a roll (after rolling up the continuous web). The membrane assemblies are surrounded by a specifically designed seal frame, wherein the seal frame is designed such that it surrounds the cathode, the anode and the membrane at their rims. This means that after connecting the first and second partial seals, the cathode, the anode and the membrane of a respective membrane assembly at their outer rims on all sides are surrounded by a frame-shaped seal. The terms frame-shaped seal or seal frame describe a seal structure formed like a picture frame or window frame and comprises inside of the membrane electrode assemblies between the respective inner edges of the seal frame a free inner region which has the form of a picture-like or window-like section. In this inner region at least partial regions of the cathode, the anode and the membrane lying upon each other are exposed, and thus, they are not covered by the seal frame. It may be that the seal frame is only connected with the edges of the cathode, the anode and the membrane, or that it partially overlaps the cathode, the anode and/or the membrane in the direction of the layer thickness of the MEA, thus in the assembly direction of the layers of the MEA. The direction of the layer thickness is also the stack direction of the MEA, thus the assembly direction of the anode, the membrane and the cathode. The seal frame is formed from the first partial seal and the second partial seal which are connected by an adhesive or by radiation-curing of an applied radiation-curable material and compressing of the assemblies with each other, in particular in a firmly bonded manner and thus in a mechanically stable manner.

The membrane electrode assemblies generated may be used in fuel cells, water electrolysis cells, electrochemical compressors and electrochemical sensors.

Further advantageously in the light of the continuous and time-efficient method guidance, the generation of first and second frame-shaped partial seals is realized by rotative die cutting, planishing or laser cutting of window-like sections from the first seal material and from the second seal material. The methods mentioned above are low-loss ones and are characterized by a high precision.

Furthermore, it is advantageous when the first seal material and the second seal material are guided in opposite directions. This results in the advantage of a space-saving mode of operation.

It is particularly efficient when the first and second partial seals are connected with each other in a manner of pre-fixing the first partial seals and the second partial seals by guiding through a pair of rollers before the adhesive material is thermally activated or before the radiation-curable material is radiation-cured, wherein at least one first roller is implemented with an elastic material. With the elastic material, it is possible to promote the pressing of the partial seals against each other so that air inclusions between the first and second partial seals are effectively prevented.

To prevent a situation in which single components of the components of the assemblies to be connected with each other are getting out of place, the thermal activation or radiation-curing and compressing are preferably conducted by guiding the assemblies through a fixing device in which thermal energy and pressure or radiation and pressure are applied onto the assemblies. This results in a reduced amount of waste of membrane electrode assemblies.

To make the thermal activation particularly efficient and to prevent damages at the assemblies at the same time, the fixing device is preferably heated to a temperature of 80° C. to 160° C., preferably of 100° C. to 140° C., wherein the thermal energy can be applied symmetrically or asymmetrically. In the use of a radiation-curable material, preferably a radiation in the wavelength 450 nm to 100 nm, preferably 420 nm to 365 nm, is chosen and is applied onto an exposed upper and an exposed lower side of the product to be produced, thus the assemblies have not yet been cured. The exposed side is the side of the assemblies which does not lie on the transport material. In the simplest example, the radiation is applied from an exposed upper side of the second partial seals so the radiation can penetrate through the assemblies without hindrance.

In the light of good seal properties, it is particularly advantageous when the pressure being applied onto the assemblies by the fixing device is 0.05 MPa to 10 MPa, preferably 0.15 MPa to 5 MPa and further preferably 0.25 MPa to 3 MPa. In pressure ranges of up to 10 MPa, the first partial seal and the second partial seal can be densified with each other to a seal frame without air inclusions, wherein, when the pressure is lower, any damages at the seal material and possibly at components of the assembly can effectively be avoided. An application of a pressure of 0.25 MPa to 3 MPa is particularly well suitable in the light of the above-mentioned advantages.

It is also advantageous when the compressing is conducted for a time of 0.006 s to 60 s, preferably of 0.2 s to 120 s, and further preferably of 0.25 s to 5 s.

Further advantageously, the cutting to size of layer assemblies from the layer assembly material is conducted such that an area of the layer assemblies to be surrounded by the frame-shaped first and second partial seals is larger than the window-like sections of the first and second partial seals. This results in the fact that partial regions of the layer assemblies overlap with the partial seals so that a particularly good layer composite results and leakage sites between layer assemblies and seal frames are effectively prevented.

Preferably, the cut layer assemblies, before they are deposited on the first frame-shaped partial seals, are transferred onto a delivery medium and are transferred from the first delivery medium onto a second delivery medium so that the individual layer assemblies become spaced apart from each other. Being spaced apart from each other is advantageous for improving an accurately fitting arrangement of the layer assemblies on the first partial seals so that a maximally large inner region of the layer assemblies can be used, when later the membrane electrode assemblies are used for the catalytic reactions.

Furthermore, it is advantageous when the layer assembly material comprises a layer assembly carrier foil so that the layer assembly material can be conveyed effectively and without delay. The cutting to size of layer assemblies is conducted such that the layer assembly carrier foil is not cut in two which promotes a continuous processing of the layer assemblies.

According to a further advantageous further development, the layer assembly carrier foil is removed from the layer assemblies in an angle of more than 90°, preferably of more than 105° and further preferably of more than 120°, before the layer assemblies are deposited on the first frame-shaped partial seals. Removing of the layer assembly carrier foil in an angle of more than 90° C. particularly well prevents deformations or (partial) delamination of components of the layer assemblies, and thus it is particularly gentle. The larger the angle, the easier and more efficient it may be to remove the layer assembly carrier foil.

Furthermore, it is advantageous when during the generation of the first frame-shaped partial seals in the first seal material, in addition, a reference mark is generated for aligning the first partial seals, the layer assemblies and the second partial seals to each other in machine direction. The reference marks have to be provided so that they allow an exact determination of the position of the window-like sections in the partial seals, and thus an overlapping region between membrane and partial seals is minimized. By providing reference marks, furthermore, layer assemblies to be positioned on the first partial seals (catalyst coated membranes) can easier be singularized and by a suitable process guidance individual layer assemblies can be spaced apart to each other.

For facilitating a positioning of the components of the assemblies to be arranged to each other, the method further comprises a step of adjusting the width of the first transport medium to the width of the first carrier foil. This means that as a result of this, a guidance of the components (first partial seals) on the transport medium is locally limited. For example, in the example of the use of a vacuum transport belt as transport medium, the vacuum which is applied here can be adjusted in its width specifically to the components to be transported so that a bypass for air is avoided so that no air leakage is generated and the vacuum can be created in a particularly stable manner so that the position of the first frame-shaped partial seals is particularly well stabilized when getting out of place.

For guaranteeing at the same time a time-saving manner of processing and a transport without getting out of place, a web velocity of the first transport medium is, in particular, between 0.1 m/min and 100 m/min, preferably between 0.5 m/min and 50 m/min and further preferably between 1 m/min and 40 m/min.

To further effectively avoid any consequential damages by temperature influences onto the membrane electrode assemblies, it is further advantageously provided that the membrane electrode assemblies after compressing are cooled.

For the protection of the first and/or second partial seal material, preferably on an exposed side of the first seal material a first protective foil and/or on an exposed side of the second seal material, a second protective foil is provided, wherein during the removal of the first protective foil and/or the second protective foil from the frame-shaped partial seals the frame-shaped partial seals are guided with high positioning accuracy. A removal of the first and/or second protective foil is preferably conducted after the generation of the first and/or second partial seals. The protective foil has the advantage of avoiding a contamination of the seal material.

Furthermore, it is advantageous when after the compression of the assemblies the membrane electrode assemblies are cut with a final contour.

Depending on how the further processing of the membrane electrode assemblies is provided, the membrane electrode assemblies with or without final contour cut further remain on a carrier foil or are singularized as piece goods, separated from the carrier foil and stacked.

For improving the quality of the generated membrane electrode assemblies, it is advantageous when each membrane electrode assembly is unambiguously labeled or marked and the label is checked for consistency and identifying quality.

Furthermore, in the light of an improvement of the quality, it is advantageous when after each process sequence the quality of the obtained membrane electrode assemblies is checked by an inspection system and, when a part is defective, a defect mark is applied, preferably onto a label such as, for example, a DataMatrix/QR code so that it is possible to identify and sort out defective parts in the following further processing steps.

It is further advantageous when each membrane electrode assembly is unambiguously labeled or marked and the label is checked for consistency and identifying quality.

Furthermore, it is advantageous when after each process sequence the quality of the obtained membrane electrode assemblies is checked by an inspection system and, when a part is defective, a defect mark is applied, preferably onto the label so that it is possible to identify and sort out defective parts in the following further processing steps.

Furthermore, we also provide a second method to produce membrane electrode assemblies. The membrane electrode assemblies are obtained in the form of a continuous web, with a layer assembly comprising a membrane between an anode and a cathode, and, in addition, comprising a frame-shaped seal as well as gas diffusion plies, wherein the frame-shaped seal at least surrounds the outer rims of the layer assembly so that an inner region of the layer assembly being surrounded by the frame-shaped seal is exposed.

The method comprises a step of providing membrane electrode assemblies in the form of roll goods with a cathode, an anode and a membrane lying in between as well as a seal frame surrounding at least the outer rims of the membrane electrode assemblies. It is possible that the membrane electrode assemblies are prepared according to the above-described first method, and then arranged on the first carrier foil. Accordingly, the respective advantageous further developments, advantages and effects of the first method are also applicable in the example of the second method.

In addition, the second method comprises an arrangement of first gas diffusion plies on first sides of the membrane electrode assemblies and/or of second gas diffusion plies on second sides of the membrane electrode assemblies. In particular, prior to the arrangement of the first gas diffusion ply or the second gas diffusion ply, the first carrier foil, if present, can be removed.

Advantageously, the membrane electrode assemblies provided with gas diffusion plies can be further guided on a second carrier foil which, for example, is arranged with the first gas diffusion ply. As a result of this, the continuous process with membrane electrode assemblies as roll goods is improved.

By the use of membrane electrode assemblies as roll goods and the further processing as roll goods in the second method, the second method is characterized by the fact that it can be conducted in a fast, reliable and cost-efficient manner and to the greatest extent in an automated manner.

In particular, the membrane electrode assemblies may comprise on each side, thus on the anode side and on the cathode side as outer layers each gas diffusion plies. The gas diffusion plies may be provided as piece goods in a stockpiling unit, or before the gas diffusion plies are used, from a gas diffusion ply roll being provided as roll goods gas diffusion plies can be singularized to piece goods. In this example, the gas diffusion plies are preferably arranged on a second carrier foil at least after the singularization. For providing the gas diffusion plies, the method according to an advantageous further development comprises arranging first gas diffusion plies on first sides of the membrane electrode assemblies and/or of second gas diffusion plies on second sides of the membrane electrode assemblies. The first side, for example, may be the anode side so that therefore the second side is the cathode side. In an alternative to that, the first side may also be the cathode side so that therefore the second side is the anode side. The gas diffusion plies are used for the distribution of the reaction gases on the respective side of the membrane electrode assemblies.

Advantageously, prior to the arrangement of the first gas diffusion plies and/or the second gas diffusion plies in rim regions of the first sides of the membrane electrode assemblies and/or in rim regions of the second sides of the membrane electrode assemblies an adhesive, an adhesion promotor or a film being adhesive on both sides is applied so that an adherence of the gas diffusion plies is improved. Alternatively, for this purpose, the frame-shaped seals can also be softened. When an adhesive film is used, then the adhesive, for example, may be selected from air-curing, thermally activatable or light-or UV-activatable adhesives or from two-part adhesives, wherein advantageously an amount of adhesive of 0.1 to 10 mg cm-1 is used and/or a layer thickness of the adhesive layer to be applied is 1 to 30 μm. When the adhesive is a UV-activatable adhesive, then the wavelength of the activating UV-light is advantageously 100 nm to 440 nm, preferably of 300 nm to 400 nm and further preferably of 350 nm to 420 nm, and, in particular, it is 395 nm. Further advantageously, the UV intensity is 1 to 30 W/cm and the duration of exposure dependent on a width of the adhesive film may be about 0.003 s to 60 s, wherein a width of the exposure is advantageously adjusted to the width of the applied adhesive. With this example of the method, gas diffusion plies can be applied in a gentle manner so that a bending of the gas diffusion plies and thus a damage of the gas diffusion plies is avoided and nevertheless still an exact positioning of the gas diffusion plies is made possible.

To improve a permanent positioning of the gas diffusion plies and be able to subsequently allow a fixing of the gas diffusion plies with high positioning accuracy, the method advantageously comprises a fixing of the first and/or second gas diffusion plies on the first and/or second sides of the membrane electrode assemblies, in particular, under using a temperature of 100 to 200° C., preferably of 140 to 180° C., and further advantageously under applying a pressure of 0.5 to 5 MPa and preferably of 1.0 to 5.0 MPa.

To place the gas diffusion plies in an accurately fitting and locally precise manner, it is further advantageously provided that positions of window-like sections of the frame-shaped seals or reference marks of the membrane electrode assemblies are determined and a positioning of the first gas diffusion plies on the second transport medium or a position of the window-like sections, or a position of the reference mark of the first sides of the membrane electrode assemblies in machine direction (this direction corresponds to the conveying direction of the membrane electrode assemblies) and in transverse machine direction (this direction corresponds to a direction perpendicular with respect to the machine direction in areal extent direction of the membrane electrode assemblies) is adjusted.

For further facilitating the method, particularly for the spatial compaction thereof according to a further advantageous further development, a transport direction of the membrane electrode assemblies and a transport direction of the first gas diffusion plies are selected such that before the gas diffusion plies and the membrane electrode assemblies are brought together, they are opposite and/or horizontal directions.

For improving the quality of the finally generated membrane electrode assemblies, the method in particular may also comprise a test for gas-tightness, wherein the membrane electrode assemblies being provided with first and second gas diffusion plies are arranged in a sealing fixing unit and the respective gas-tightness of the membrane electrode assemblies is determined under using a test gas. This test for gas-tightness can be integrated into the continuous conveying process of the membrane electrode assemblies and thus improves the simple and time-saving generation of highly functional membrane electrode assemblies.

It is further advantageous that after the compressing of the assemblies or after the arranging and fixing of the first gas diffusion plies on the first sides of the membrane electrode assemblies and/or the second gas diffusion plies on the second sides of the membrane electrode assemblies, the membrane electrode assemblies can be cut with a final contour.

Depending on how the further processing of the membrane electrode assemblies is provided, the membrane electrode assemblies with or without final contour cut further remain on a (second) carrier foil or are singularized as piece goods, separated from the carrier foil and stacked.

For improving the quality of the generated membrane electrode assemblies, it is advantageous when each membrane electrode assembly is unambiguously labeled or marked and the label is checked for consistency and identifying quality.

Furthermore, in the light of an improvement of the quality, it is advantageous when after each process sequence the quality of the obtained membrane electrode assemblies is checked by an inspection system and, when a part is defective, a defect mark is applied, preferably onto a label such as, for example, a DataMatrix/QR code so that it is possible to identify and sort out defective parts in the following processing steps.

It is further advantageous when each membrane electrode assembly is unambiguously labeled or marked and the label is checked for consistency and identifying quality.

Furthermore, it is advantageous when after each process sequence the quality of the obtained membrane electrode assemblies is checked by an inspection system and, when a part is defective, a defect mark is applied, preferably onto the label so that it is possible to identify and sort out defective parts in the following further processing steps.

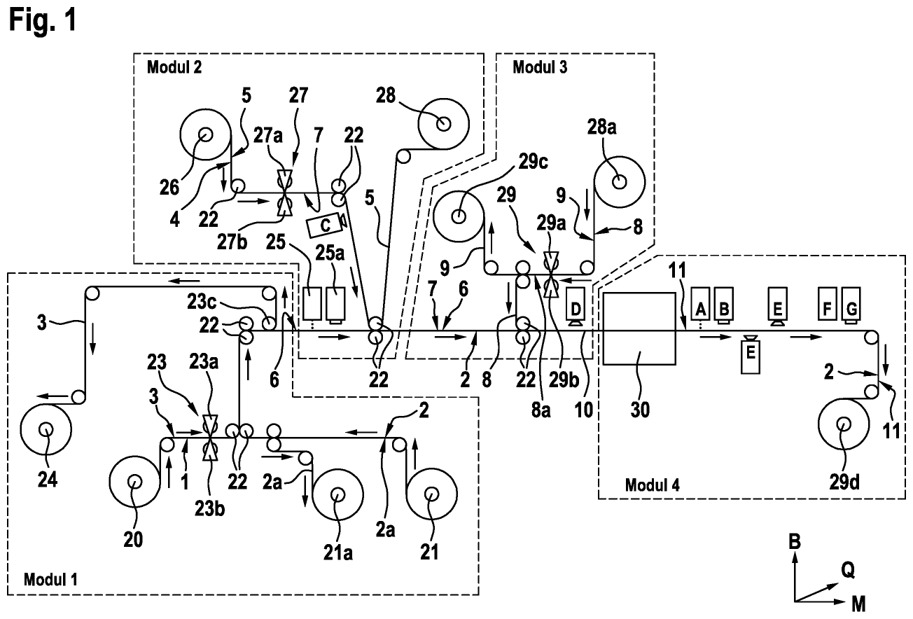

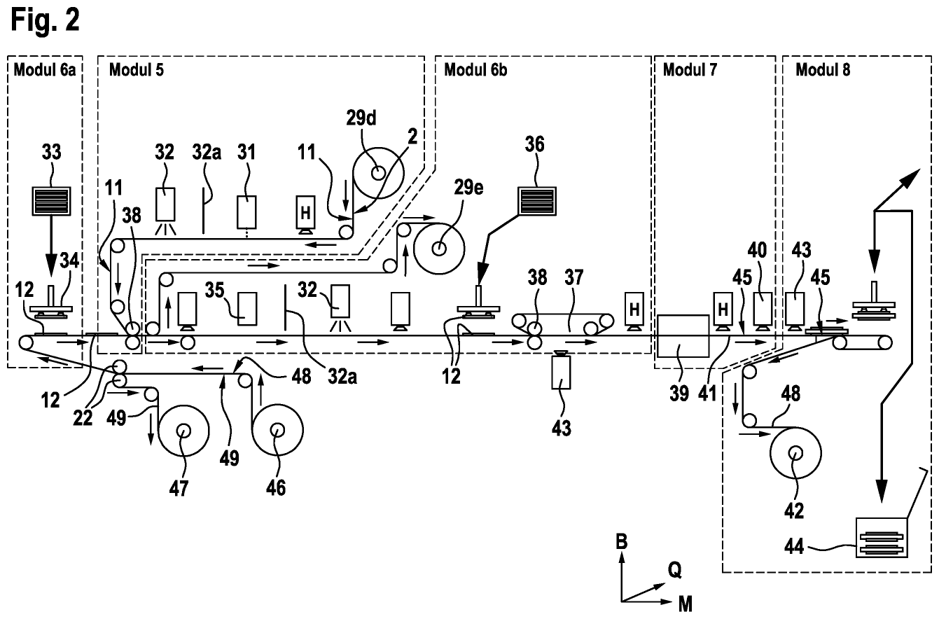

In FIGS. 1 and 2, only the essential aspects and components are shown. For clarity, all other aspects are omitted. Furthermore, the same reference signs are used for the same device elements/components.

In detail, FIG. 1 shows on the basis of a schematic device method steps to produce three-ply membrane electrode assemblies in the form of a three-ply continuous web for the use in fuel cells, water electrolysis cells, electrochemical compressors and electrochemical sensors, wherein the membrane electrode assemblies comprise a seal frame comprising a first and a second partial seal as well as a catalyst coated membrane (CCM). The method steps are divided into modules 1 to 4. The method is fast, reliable and cost-efficient and can be most widely conducted in an automated manner.

In module 1, from a first roll 20 a first seal material 1 is provided as roll goods. The first seal material 1 comprises on its upper side a first protective foil 3. At first, the first seal material 1 is conditioned, thus positioned without wrinkles with respect to the transverse machine direction Q and centrically in relation to the width of the device. The first seal material 1 being arranged with the first protective foil 3 is then fed to a cutting device 23 comprising a third roll 23a and a rotating blade 23b (in an alternative also to a planishing tool or a laser cutting tool). Then, from a second roll 21 a first carrier foil 2 with a cover foil 2a is provided and, after removing the cover foil 2a and rolling it up on a further roll 21a, the first seal material 1 is arranged on the first carrier foil 2 by guiding the first seal material 1 and the first carrier foil 2 via guiding rolls 22 (pair of rollers). Subsequently, under removing the protective foil 3 inclusively seal material cutting scrap of the seal material 1 via delamination roll 23c from the first seal material 1 first partial seals 6 are formed which are present with a frame-shaped or window frame-like form and thus comprise window-like sections within the inner edges of the first partial seals 6. The first protective foil 3 with the seal material cutting scrap is rolled up on the fourth roll 24.

At first, in module 2, marking of the first partial seals 6 with a reference mark by a marking device 25 and checking of the created mark by a mark testing device 25a is conducted. The reference mark may be applied by die cutting, cutting or lasing. In some instances, already during the generation of the window-like sections a reference mark is, in addition, generated in the first partial seals 6 by the same tool in the same method step. By the generation of the window-like sections in the first seal material 1 and the reference marks in one process step at the same time, in particular by the use of the same tool in a rotative cutting process, an exact positioning of the reference marks in relation to the window-like sections is obtained. The exact position of the reference marks and thus the window-like sections is preferably determined via a camera system. In the subsequent process steps the reference marks can be determined via sensors or camera systems and they serve as time base for the alignment of all further components, i.e. for the layer assemblies 7 and second partial seals 8a and thus for the alignment of the layer assemblies 7 and the second partial seals 8a in machine direction M with respect to the first partial seals 6. A very stable process guidance with respect to the alignment of the subsequent components, i.e. the layer assemblies 7 and the second partial seals 8a, is realized. The reference marks can be identified by cameras and/or sensors, whereby a signal for the synchronization and timing of the layer assemblies 7 and the second partial seals 8a is generated. Furthermore, the feed velocity of the layer assemblies 7 and the second partial seals 8a can be controlled such that an exact positioning of the layer assemblies 7 and the second partial seals 8a in relation to the first partial seals 6 is obtained. The position of the layer assemblies 7 is in particular determined via camera systems which identify the edge of the layer assemblies 7 in machine direction M and convert this information into signals which can be synchronized with the signals of the reference marks of the first partial seals 6.

Furthermore, from a fifth roll 26 a layer assembly material 4 consisting of anode, cathode and membrane lying in between in the form of roll goods is provided. A positioning of the layer assembly material 4 in transverse machine direction Q is realized centrically in relation to a width of the device. The exact positioning of the layer assembly material 4 in transverse machine direction Q can be fine-tuned via the use of further guiding rolls 22. The layer assembly material 4 is provided on a layer assembly carrier foil 5, by which the layer assembly material 4 is fed to a cutting device 27 comprising a sixth roll 27a and a rotating blade 27b, in which from the layer assembly material 4 layer assemblies 7 are generated, wherein the format of which is adjusted to the window-like sections of the first partial seals 6. The format of the layer assemblies 7 is in particular chosen greater than that of the window-like sections of the first partial seals 6 so that an overlapping region in the periphery of the layer assemblies 7 with the first partial seals 6 is created. The size of the overlapping region is chosen so large that a gas-tight arrangement of layer assemblies 7 and frame-shaped seals to be formed is made possible, and so small that the loss of active area of the layer assemblies 7 is minimized. Preferably, the overlapping region is 0.5 mm to 6 mm and further preferably between 1 mm and 3 mm.

By the guiding of the layer assemblies 7 which are still arranged on the layer assembly carrier foil 5 through guiding rolls 22, the layer assemblies 7 under removing the layer assembly carrier foil 5 which is then rolled up on a seventh roll 28 are arranged on the first partial seals 6. An exact positioning of the layer assemblies 7 in the frame-shaped first partial seals 6 is achieved by aligning the layer assemblies 7 with respect to the reference marks being applied on the first partial seals 6.

Thus, in module 3, on the first carrier foil first partial seals 6 are present, and on their upper side layer assemblies 7 are arranged.

In module 3 from an eighth roll 28a a second seal material 8 on a second protective foil 9 is provided. When module 1 and module 3 are compared, then it can be seen that the first seal material 1 and the second seal material 8 are guided in opposite directions, whereby a particularly compact structure and design of the device is achieved. Now, the second seal material 8 is fed to a cutting device 29 comprising a ninth roll 29a and a rotating blade 29b such that under removing the second protective foil 9 from the second seal material 8 in the cutting device 29 second partial seals 8a are generated, which are then redirected by a further guiding roll 22 arranged on the layer assemblies 7, namely such that the window-like sections of the first partial seals 6 come to lie above the window-like sections of the second partial seals 8a being generated in the cutting device 29. Inside of the window-like sections the layer assemblies are present so that an area of the membrane which is as large as possible is exposed inside of the frame-shaped partial seals 6, 8a. The second protective foil 9 after its removal is rolled up on a tenth roll 29c. As already described for the first partial seals 6, the second partial seals 8a can be provided with reference marks for facilitating a better positioning of the second partial seals 8a on the first partial seals 6.

The first partial seals 6, the layer assemblies 7 and the second partial seals 8a which in this order are stacked one upon the other in direction B, form assemblies 10.

In module 4, a fixing of the first and second partial seals 6, 8a with the layer assemblies 7 in a fixing device 30, in particular after checking the layer assemblies 7 being produced hitherto by sensor D, is realized. For this purpose, on the first seal material 1 and/or on the second seal material 8 an adhesive material is arranged such that after the arrangement of the first partial seals 6, the layer assemblies 7 and the second partial seals 8a one upon the other the adhesive material is arranged between the first and second partial seals 6, 8a being arranged one upon the other. In the fixing device 30 which may, for example, be designed as heated pair of pressing jaws, then a thermal activation of the adhesive material and compressing of the assemblies 10 is realized, wherein membrane electrode assemblies 11 with frame-shaped seals as continuous roll goods on carrier foil 2 are obtained. Via the adhesive material a firmly bonded, mechanically stable and gas-tight composite consisting of layer assemblies 7 and seal frames is obtained.

Here pressing jaws of the pair of pressing jaws to fix the partial seals and generate a seal frame or any rollers of a pair of rollers for fixing can be manufactured from different materials, and the materials are in particular selected from the group of metal, rubber, rubberized metal or coated metal. Furthermore, the material is selected such that an adherence of the continuous web assemblies 10 at the pressing jaws or rollers is avoided. The material of the pressing jaws or the rollers is designed such that a homogenous distribution of the pressure during the fixing is achieved and that differences in thickness in the overlapping region of partial seals and layer assemblies are balanced. Coatings are selected, for example, from the group of Viton or PTFE.

Furthermore, the temperature of the upper and lower pressing jaws of the pair of pressing jaws or the temperature of the upper and lower rollers of the pair of rollers can be different. In particular, the temperature of the lower element each is between 40° C. and 160° C., preferably between 50° C. and 140° C., and the temperature of the upper element each is between 80° C. and 200° C., preferably between 100° C. and 180° C. Furthermore, the pair of pressing jaws and the pair of rollers generate, in particular, a pressure of between 0.05 MPa and 10 MPa, preferably between 0.15 MPa and 5 MPa and further preferably between 0.25 MPa and 3 MPa. A sufficient activation of the adherent adhesive material is achieved and a firmly bonded connection free of bubbles between layer assemblies and first and second partial seals is achieved.

In some instances, the pair of pressing jaws is arranged on a rail in a movable manner. A continuous process guidance is facilitated because the step of putting under seal of both partial seals follows the movement of the continuous web in the machine direction M. The continuous process guidance is particularly efficient and furthermore increases the precision of the process because discontinuities of the web movement in the sense of periodically stopping and starting the web are avoided.

In some instances, the composite consisting of layer assemblies and first and second partial seals, the so-called assemblies, after the fixing between the pair of pressing jaws or the pair of rollers, is cooled on a cooled transport belt. This process step is used to cure the adhesive material, whereby the cutting ability of the partial seals is improved.

The membrane electrode assemblies 11 being obtained as continuous roll goods with frame-shaped seals can subsequently be rolled up on an eleventh roll 29d. This is possible particularly well due to the fact that the membrane electrode assemblies 11 still are present on the first carrier foil 2.

Advantageously, in exemplarily provided devices A, B, C, E, F and G an application of a DataMatrix code can be realized and controlled. For this purpose, for example, in device A a DataMatrix code can be applied; in device B a check of a DataMatrix code can be conducted; in device C a QC-CCM—i.e. a quality control of the membrane electrode assemblies 7 (CCM) can be conducted by an optical inspection system; in device E a QC-3-L—i. e. a quality control of the three-ply MEA (on both sides) can be conducted by an optical inspection system, which makes the quality of the composite consisting of layer assemblies and first and second partial seals and/or a gas-tightness test possible. In addition, also a device F for defect marking can be provided, and/or in device G a verification of a defect mark can be conducted.

As shown in FIG. 1, the method results in the production of a continuous web of three-ply membrane electrode assemblies (membrane with anode and cathode) and shows, compared to common methods, advantages with respect to the efficiency, automation and logistics in the method guidance, wherein at any time point a continuous and thus time-efficient component guidance and processing are guaranteed.

In the generated three-ply membrane electrode assemblies 11 catalyst coated membranes are present which can be understood as a composite consisting of an anode, a cathode as well as a membrane being present between anode and cathode and, in particular, being able to conduct protons. The catalyst coated membranes are present in the form of a continuous web, thus, in other words, as roll (after rolling up the continuous web), and are surrounded by a specifically formed seal frame.

FIG. 2 shows in detail with the help of a schematic device method steps for the production of five-ply membrane electrode assemblies 45 in the form of a five-ply continuous web for the use in fuel cells, water electrolysis cells, electrochemical compressors and electrochemical sensors, wherein the membrane electrode assemblies 45 comprise a seal frame comprising a first and a second partial seal as well as a catalyst coated membrane (CCM) as well as gas diffusion layers. The method steps are divided into modules 5 to 8. The method is fast, reliable and cost-efficient and can be most widely conducted in an automated manner.

In the method shown in FIG. 2, the three-ply membrane electrode assemblies 11 which were prepared according to the first method shown in a schematic manner and the device of FIG. 1 can be used. It is essential that the membrane electrode assemblies to be used comprise a membrane, an anode and a cathode flanking the membrane on opposite sides of the membrane and comprising a seal frame which surrounds the membrane, and are present as roll goods, carried on a first carrier foil 2.

In module 5, membrane electrode assemblies 11 obtained as continuous roll goods which are present on a first carrier foil 2 on an eleventh roll 29d are unrolled from the eleventh roll 29d, their arrangement is checked by a sensor H and they are fed to a first adhesive application device 31 so that an exposed upper side of the membrane electrode assemblies 11 is provided with adhesive which covers at least partial regions of the frame-shaped seals and subsequently is cured in a curing device 32 for the adhesive. The vertical line between the adhesive application device 31 and the curing device 32 represents a protective device 32a which protects the adhesive from premature solidification.

The adhesive is in particular selected from the group of air-curing, thermally activated or light-or UV-activated adhesives or two-part adhesives. The application of the adhesive onto the periphery of the window-like sections of the frame-shaped seals can be realized by a single application system or also by two application systems which apply an L-shaped adhesive pattern each, or also by several application systems which apply a linear adhesive pattern each. As application system, systems which are known by a person skilled in the art and which can be understood as a system consisting of pumps and nozzles which is suitable for the application of adhesive around the periphery of the window-like sections can be used.

Then, in module 6a, from a 13th roll 46 a second carrier foil 48 is unrolled which for protection is provided with a cover foil 49. During guiding through a pair of rollers 22, the cover foil 49 is removed and is rolled up on a 14th roll 47.

In addition, in module 6a, from a magazine 33 prepared and conditioned gas diffusion plies 12 are transferred onto the second carrier foil 48 and fed to a gas diffusion ply application device 34 in which gas diffusions plies 12 are fed to the upper sides of the membrane electrode assemblies 11 being provided with adhesive, and it is pressed with the pressing facility 38. After passing the pressing device 38, the first carrier foil 2 is removed and is rolled up on a twelfth roll 29e.

In module 6b, the membrane electrode assemblies are fed to a second adhesive application device 35, wherein onto a second upper side of the membrane electrode assemblies now being exposed adhesive is applied. Subsequently, further gas diffusion plies 12 from a magazine 36 are fed to the second upper side of the membrane electrode assemblies being provided with adhesive. Subsequently, the gas diffusion plies 12 are pressed on the membrane electrode assemblies 11 by a 15th roll 38. By a vacuum transport belt 37 the membrane electrode assembly 11 and the gas diffusion plies 12 are held on the first upper side so that the membrane electrode assemblies 11 with the gas diffusion plies 12 are held during the further transport so that the lower side of the membrane electrode assembly 11 and the lower gas diffusion plies 12 are exposed.

Furthermore, it may be envisaged that the position of the window-like sections of the partial seals is determined by sensors H and the positioning of the first gas diffusion ply 12 on the vacuum transport belt 37 is adjusted to the position of the window-like or frame-shaped sections in machine direction M and transverse machine direction Q. So, an accurately fitting positioning of the first gas diffusion ply 12 with respect to the window-like sections becomes possible, whereby a composite with high power density and long service life is obtained.

In module 7, a final contour blank cut of the membrane electrode assemblies being provided with gas diffusion plies 12 is made by cutting device 39, namely in such a manner that the carrier foil 1 is not damaged and, therefore, the membrane electrode assemblies being provided with gas diffusion plies 12 are still arranged on the first carrier foil 1. The membrane electrode assemblies can be separated from each other by the cutting device 39, and so they can be prepared for singularization, or they are not separated, and so they are furthermore present as roll goods. Furthermore, a quality control is conducted by a camera system 40. The camera system 40 comprises a camera which checks the cutting quality as well as the dimension of the window-like sections, and thus guarantees the plausibility, thus the use of the correct tool.

The membrane electrode assemblies 45 being provided with gas diffusion plies 12 are transported and conveyed on a transport medium 41, wherein the second carrier foil 48 by rolling up on a 16th roll 42 is removed from the membrane electrode assemblies, and the finished membrane electrode assemblies 45 after the final quality control in module 8 by camera system 43 either, when their quality is not sufficient, are sorted out or, when the quality is sufficient, are stocked for further processing or storage in storage container 44. The further camera system 43 may, in addition, be installed above and below the continuous web, and it checks the alignment of the layer assemblies and the first partial seals as well as the alignment of the layer assemblies and the second partial seals. It is guaranteed that the window-like sections of the first and second partial seals are congruently arranged. Furthermore, this camera system can check the quality of the rim foil pre-fixing with respect to a wrinkle-and bubble-free condition. Furthermore, additional cameras (QC camera) can check the quality of the composite being put under seal consisting of layer assemblies and first and second partial seals with respect to a bubble-free and wrinkle-free condition.

Also according to the method shown in FIG. 2 and the schematized device for conducting the method, the method results in the production of a continuous web of membrane electrode assemblies which however now are five-ply ones (membrane with anode, cathode and two gas diffusion plies), and shows in comparison to common methods advantages with respect to the efficiency, automation and logistics in the method guidance, wherein at any time point a continuous and thus time-efficient component guidance and processing are guaranteed.

In the generated five-ply membrane electrode assemblies, catalyst coated membranes and gas diffusion plies are present which are implemented with high positioning accuracy. The five-ply membrane electrode assemblies may be present in the form of a continuous web on a roll, or they may be finally cut to size for further processing.

The device shown in FIG. 2 may in an alternative also be used to provide three-ply membrane electrode assemblies having a final, contour-imparting blank cut. Then, from the magazines 33 and 36 no gas diffusion plies are conveyed.

In addition to the above written description, reference is made explicitly to the graphic representation FIGS. 1 and 2 for supplementary disclosure thereof.

1.-15. (canceled)

16. A method for the production of membrane electrode assemblies in the form of a continuous web, wherein the membrane electrode assemblies each comprise a layer assembly with a membrane which is arranged between an anode and a cathode as well as a frame-shaped seal which at least surrounds the outer rims of the layer assembly so that an inner region of the layer assembly being surrounded by the frame-shaped seal is exposed, the method comprising the steps:
providing of a first seal material as roll goods, wherein the first seal material is arranged on a first protective foil,
providing of a second seal material as roll goods, wherein the second seal material is arranged on a second protective foil,
generating of first frame-shaped partial seals from the first seal material so that the first protective foil is not damaged,
arranging of a first carrier foil on the first partial seals,
generating of second frame-shaped partial seals from the second seal material so that the second protective foil is not damaged,
feeding and depositing of the first frame-shaped partial seals on a web-shaped transport material being arranged on a first transport medium under removing the first protective foil,
providing of layer assembly material consisting of anode, cathode and membrane lying in between as roll goods,
cutting into size of layer assemblies from the layer assembly material,
depositing of the layer assemblies on the first frame-shaped partial seals being present on the transport material,
feeding and depositing of the second frame-shaped partial seals on the layer assemblies being arranged on the first frame-shaped partial seals under removing the second carrier foil so that window-like sections of the first frame-shaped partial seals and window-like sections of the second frame-shaped partial seals are congruently arranged and assemblies are obtained,
wherein on the first seal material and/or on the second seal material an adhesive material is arranged such or a radiation-curable material is arranged such that after arranging the first partial seals, the layer assemblies and the second partial seals one upon the other the adhesive material or the radiation-curable material is arranged between the first and second partial seals being arranged one upon the other,
thermally activating of the adhesive material or radiation-curing of the radiation-curable material and
compressing of the assemblies under obtaining membrane electrode assemblies with frame-shaped seals as continuous roll goods, arranged on the web-shaped transport material.

17. The method according to claim 16, wherein the generating of first and second frame-shaped partial seals is conducted by rotative die cutting, planishing or laser cutting of window-like sections from the first seal material and from the second seal material.

18. The method according to claim 16, wherein the first seal material and the second seal material are guided in opposite directions and/or
wherein the first partial seals and the second partial seals are pre-fixed by guiding through a pair of rollers, before the adhesive material is thermally activated or the radiation-curable material is radiation-cured, wherein at least one roller is implemented with an elastic material.

19. The method according to claim 16, wherein the thermal activation or radiation-curing and compressing is realized by guiding the assemblies through a fixing device in which thermal energy and pressure or radiation and pressure are applied onto the assemblies.

20. The method according to claim 19, wherein the fixing device (30) is heated to a temperature of 80° C. to 160° C., preferably of 100° C. to 140° C., wherein the thermal energy is applied symmetrically or asymmetrically, or a radiation having a wavelength of from 450 nm to 100 nm is applied onto an exposed upper and an exposed lower side of the assemblies (10).

21. The method according to claim 19, wherein the radiation wavelength is from 420 nm to 365 nm.

22. The method according to claim 19, wherein the pressure being applied by the fixing device onto the assemblies is 0.05 MPa to 10 MPa, preferably 0.15 MPa to 5 MPa and further preferably 0.25 MPa to 3 MPa.

23. The method according to claim 22, wherein the pressure being applied by the fixing device onto the assemblies is 0.15 MPa to 5 MPa.

24. The method according to claim 22, wherein the pressure being applied by the fixing device onto the assemblies is 0.25 MPa to 3 MPa.

25. The method according to claim 16, wherein the compressing is conducted for 0.006 s to 60 s, preferably for 0.2 s to 120 s, and further preferably for 0.25 s to 5 s and/or
wherein the cutting to size of layer assemblies from the layer assembly material is conducted such that an area of the layer assemblies to be surrounded by the frame-shaped first and second partial seals is larger than the window-like sections of the first and second partial seals (6, 8a) and/or
wherein the cut layer assemblies, before they are deposited on the first frame-shaped partial seals, are transferred onto a delivery medium and from the first delivery medium are transferred onto a second delivery medium so that the individual layer assemblies become spaced apart from each other.

26. The method according to claim 16, wherein the layer assembly material further comprises a layer assembly carrier foil and the cutting to size of the layer assemblies is realized such that the layer assembly carrier foil (5) is not cut in two.

27. The method according to claim 26, wherein the layer assembly carrier foil, before the layer assemblies are deposited on the first frame-shaped partial seals, is removed from the layer assemblies in an angle of more than 90°, preferably of more than 105° and further preferably of more than 120°.

28. The method according to claim 16, wherein during the generation of the first frame-shaped partial seals in the first seal material, in addition, a reference mark is generated for aligning the first partial seals, the layer assemblies and the second partial seals to each other in machine direction (M) and/or
the method comprises a step of adjusting the width of the first transport medium to the width of the first carrier foil and/or
wherein a web velocity of the first transport medium is between 0.1 m/min and 100 m/min, preferably between 0.5 m/min and 50 m/min and further preferably between 1 m/min and
40 m/min and/or
wherein the membrane electrode assemblies after compressing are cooled and/or
wherein on an exposed side of the first seal material the first protective foil and/or on an exposed side of the second seal material the second protective foil is provided and wherein during the removal of the first protective foil and/or the second protective foil from the first or second frame-shaped partial seals the frame-shaped partial seals are guided with high positioning accuracy and/or
wherein after the compressing of the assemblies the membrane electrode assemblies are cut with a final contour and/or
wherein the membrane electrode assemblies with or without final contour cut further remain on the first carrier foil or are singularized as piece goods, separated from the first carrier foil and stacked and/or
wherein each membrane electrode assembly is unambiguously labeled or marked and the label is checked for consistency and identifying quality and/or
wherein after each process sequence the quality of the obtained membrane electrode assemblies is checked by means of an inspection system and, when a part is defective, a defect mark is applied, preferably onto the label so that it is possible to identify and sort out defective membrane electrode assemblies in the following further processing steps.

29. A method for the production of membrane electrode assemblies in the form of a continuous web, wherein the membrane electrode assemblies each comprise a layer assembly with a membrane which is arranged between an anode and a cathode, a frame-shaped seal as well as gas diffusion plies, wherein the frame-shaped seal at least surrounds the outer rims of the layer assembly so that an inner region of the layer assembly being surrounded by the frame-shaped seal is exposed, the method comprising the steps:
providing of membrane electrode assemblies in the form of roll goods with a cathode, an anode and a membrane lying in between as well as a seal frame surrounding at least the outer rims of the membrane electrode assemblies and
arranging of first gas diffusion plies on first sides of the membrane electrode assemblies and/or of second gas diffusion plies on second sides of the membrane electrode assemblies.

30. The method according to claim 29, wherein prior to the arrangement of the first gas diffusion plies and/or the second gas diffusion plies in rim regions of the first sides of the membrane electrode assemblies and/or in rim regions of the second sides of the membrane electrode assemblies an adhesive, an adhesion promotor or a film being adhesive on both sides is applied or the frame-shaped seals are softened.

31. The method according to claim 30, comprising a fixing of the first and/or second gas diffusion plies on the first and/or second sides of the membrane electrode assemblies, using a temperature of 100 to 200° C. and applying a pressure of 0.5 to 5 MPa.

32. The method according to claim 31, wherein the temperature is 140 to 180° C. and the pressure is 1.0 to 5.0 MPa.

33. The method according to claim 29, wherein a transport direction of the membrane electrode assemblies and a transport direction of the first gas diffusion plies are opposite and/or horizontal directions.

34. The method according to claim 29, wherein the membrane electrode assemblies being provided with first and second gas diffusion plies are arranged in a sealing fixing unit and the respective gas-tightness of the membrane electrode assemblies is determined using a test gas and/or
wherein after the compressing of the assemblies or after the arranging and fixing of the first gas diffusion plies on the first sides of the membrane electrode assemblies and/or the second gas diffusion plies on the second sides of the membrane electrode assemblies the membrane electrode assemblies are cut with a final contour and/or
wherein the membrane electrode assemblies with or without final contour cut remain on a second carrier foil or are singularized as piece goods, separated from the second carrier foil and stacked and/or
wherein each membrane electrode assembly is unambiguously labeled or marked and the label is checked for consistency and identifying quality and/or
wherein after each process sequence the quality of the obtained membrane electrode assemblies is checked by means of an inspection system, and, when a part is defective, a defect mark is applied, preferably onto the label so that it is possible to identify and sort out defective parts in the following further processing steps.
